(19) United States
(12) Patent Application Publication
(10) Pub. No.: US 2018/0115513 A1
(43) Pub. Date: Apr. 26, 2018

(54) CONTROL METHOD AND INFORMATION PROCESSING DEVICE

(71) Applicant: FUJITSU LIMITED, Kawasaki-shi (JP)

(72) Inventor: Kenzo Noda, Naruto (JP)

(73) Assignee: FUJITSU LIMITED, Kawasaki-shi (JP)

(21) Appl. No.: 15/695,177

(22) Filed: Sep. 5, 2017

(30) Foreign Application Priority Data
Oct. 21, 2016 (JP) 2016-207005

(51) Int. Cl. H04L 29/12; H04L 12/24

(52) U.S. Cl. CPC H04L 61/2053; H04L 61/2007; H04L 67/025; H04L 61/6022; H04L 41/22

(57) ABSTRACT

Provided is a non-transitory computer-readable storage medium storing a control program that causes a processor to execute a process, the process including: obtaining from a specific device one or multiple network addresses assigned to the specific device; and at a time of displaying the obtained one or multiple network addresses as a candidate for a network address used to remotely control the specific device, when the candidate includes a used network address that was used for past communication between the specific device and the processor, displaying the used network address distinctively from a remaining network address.

### CROSS-REFERENCE TO RELATED APPLICATION

This application is based upon and claims the benefit of priority of the prior Japanese Patent Application No. 2016-207005 filed on Oct. 21, 2016, the entire contents of which are incorporated herein by reference.

### FIELD

A certain aspect of the embodiments is related to a non-transitory computer-readable storage medium, a control method, and an information processing device.

### BACKGROUND

It has been known that an operator remotely logs in a user terminal subject to support from a terminal that serves remote support (remote maintenance), and remotely operates the user terminal as disclosed in, for example, Japanese Patent Application Publication No. 2014-134939.

### SUMMARY

According to an aspect of the embodiments, there is provided a non-transitory computer-readable storage medium storing a control program that causes a processor to execute a process, the process including: obtaining from a specific device one or multiple network addresses assigned to the specific device; and at a time of displaying the obtained one or multiple network addresses as a candidate for a network address used to remotely control the specific device, when the candidate includes a used network address that was used for past communication between the specific device and the processor, displaying the used network address distinctively from a remaining network address.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for describing an exemplary information processing system;

FIG. 2 illustrates a hardware configuration of a control device in a remote connection terminal;

FIG. 3 is an exemplary functional block diagram of the remote connection terminal, a server, and a connected terminal;

FIG. 4 is a flowchart (No. 1) of an exemplary operation of the connected terminal;

FIG. 5 is a flowchart (No. 2) of the exemplary operation of the connected terminal;

FIG. 6 is a flowchart (No. 1) of an exemplary operation of the server;

FIG. 7 is a flowchart (No. 2) of the exemplary operation of the server;

FIG. 8 illustrates a device list screen in accordance with a first embodiment;

FIG. 9 is a diagram illustrating a state where a device operation is expanded;

FIG. 10 is a flowchart (No. 3) of the exemplary operation of the server;

FIG. 11 is a flowchart (No. 4) of the exemplary operation of the server;

FIG. 12 illustrates a remote operation screen in accordance with the first embodiment;

FIG. 13 is a flowchart (No. 1) of exemplary selection procedures of an administrator;

FIG. 14 is a flowchart (No. 2) of the exemplary selection procedures of the administrator;

FIG. 15A is a flowchart of exemplary first update procedures, and FIG. 15B is a flowchart of exemplary second update procedures;

FIG. 16 illustrates a device detail screen;

FIG. 17 is a flowchart (No. 5) of the exemplary operation of the server;

FIG. 18 is a flowchart (No. 6) of the exemplary operation of the server;

FIG. 19 illustrates the device list screen in accordance with a second embodiment; and

FIG. 20 illustrates the remote operation screen in accordance with the second embodiment.

### DESCRIPTION OF EMBODIMENTS

Depending on the network state, it is not always possible to connect to the user terminal subject to remote login. For example, when the network address that was available for connection to the user terminal in the past has been updated and changed, the connection to the user terminal may fail.

Hereinafter, embodiments for carrying out the present case will be described with reference to the accompanying drawings.

### First Embodiment

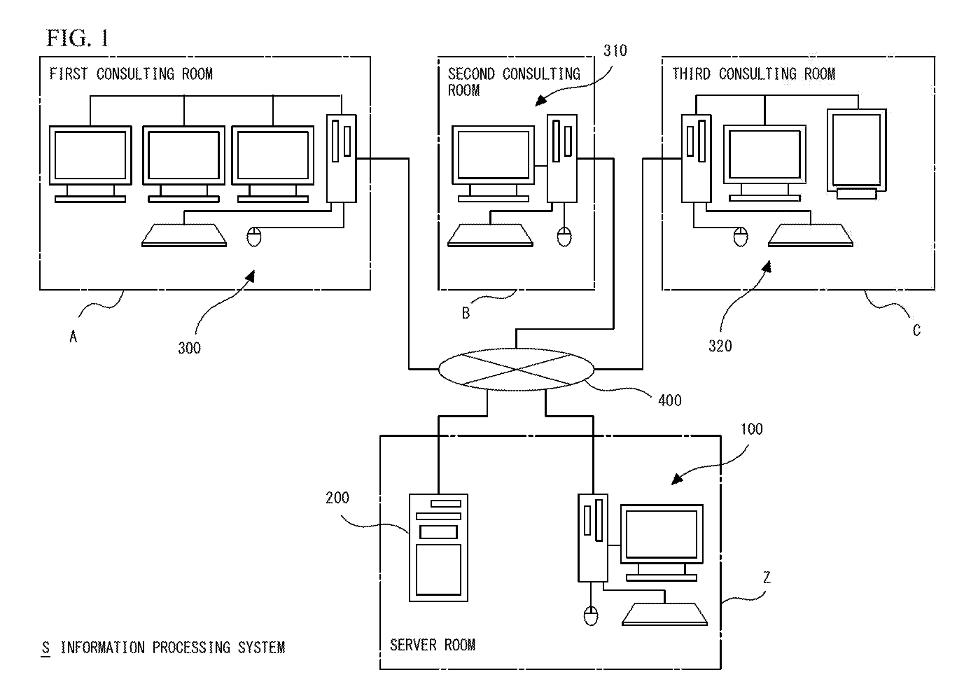

FIG. 1 is a diagram for describing an information processing system S. The information processing system S includes a remote connection terminal 100 as an information processing device, a server 200, and a plurality of connected terminals 300, 310, and 320. The remote connection terminal 100, the server 200, and the connected terminals 300, 310, and 320 are interconnected through a communication network 400. Examples of the communication network 400 include, but are not limited to, a wired Local Area Network (LAN) and a wireless LAN. In FIG. 1, personal computers (PCs) are illustrated as examples of the remote connection terminal 100 and the connected terminals 300, 310, and 320, but the remote connection terminal 100 and the connected terminals 300, 310, and 320 are not limited to PCs, and may be smart devices having wireless communication functions such as tablet terminals.

The remote connection terminal 100 and the server 200 are installed in a server room Z of a medical institution. On the other hand, the connected terminals 300, 310, and 320 are respectively installed in, for example, a first consulting room A, a second consulting room B, and a third consulting room C of the medical institution. The connected terminals 300, 310, and 320 are operated as electronic health record systems by medical professionals such as doctors and nurses. The connected terminals 300, 310, and 320 access the server 200 based on operations made by medical professionals, obtain information necessary for medical care from the server 200, and display the obtained information. That is, the server 200 serves the function of an electronic health record server.

The server 200 stores device information for managing the connected terminals 300, 310, and 320 installed in the medical institution and network information set to each of the network adaptors of the connected terminals 300, 310, and 320 (hereinafter, referred to as NW information). That is, the server 200 serves the function of a DB server. The function of the electronic health record server and the function of the DB server may be separately assigned to separate servers 200. The above device information includes a terminal ID or a computer name for identifying each of the connected terminals 300, 310, and 320, an Internet Protocol (IP) address and a Media Access Control (MAC) address assigned to each of the connected terminals 300, 310, and 320, and a network type for identifying the connection mode of each of the connected terminals 300, 310, and 320 from a wired LAN and a wireless LAN. The above NW information includes the priority order, the network I/F (interface) type, the network I/F name, one or multiple MAC addresses, the connection state, one or multiple IP addresses, and the subnet mask of a use network.

The remote connection terminal 100 is used by an administrator who manages the device information. For example, based on operations made by the administrator, the remote connection terminal 100 connects to the connected terminal 300, and obtains the screen information of a screen displayed by the connected terminal 300 (hereinafter, referred to as a remote screen). When obtaining the screen information, the remote connection terminal 100 superimposingly displays the remote screen according to the obtained screen information on a screen that the remote connection terminal 100 displays.

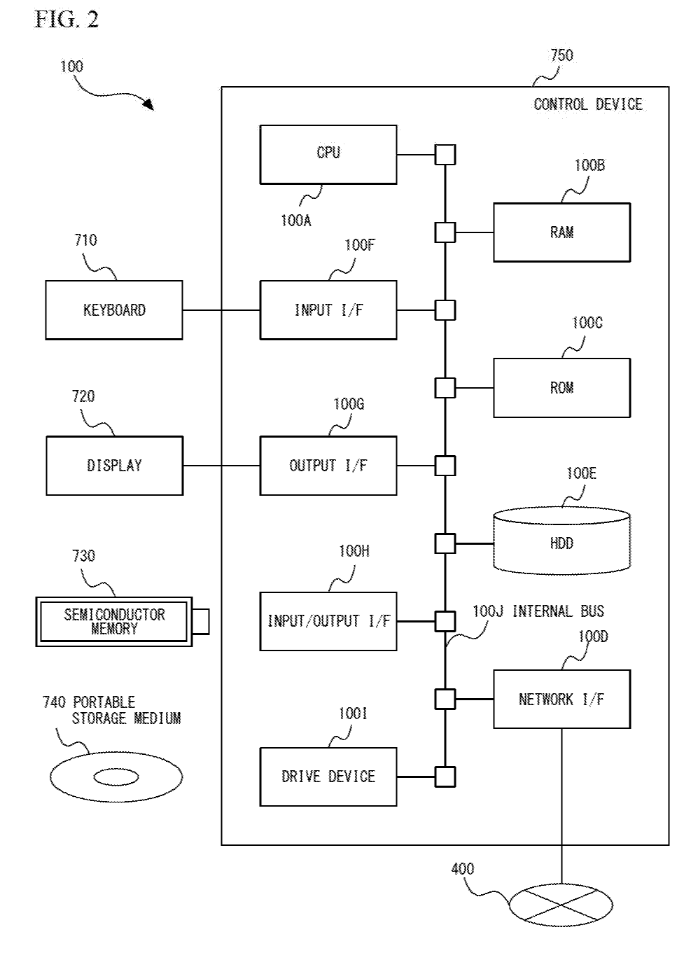

Hereinafter, the details of the information processing system S will be described with reference to the accompanying drawings. FIG. 2 illustrates a hardware configuration of a control device 750 in the remote connection terminal 100. The server 200 and the connected terminals 300, 310, and 320 basically have the same configuration as the control device 750, and the description thereof is thus omitted.

The control device 750 includes at least a central processing unit (CPU) 100A, a random access memory (RAM) 100B, a read only memory (ROM) 100C, and a network I/F 100D. The control device 750 may include at least one of a hard disk drive (HDD) 100E, an input I/F 100F, an output I/F 100G, an input/output I/F 100H, and a drive device 100I as necessary. The CPU 100A through the drive device 100I are interconnected through an internal bus 100J. The cooperation of at least the CPU 100A and the RAM 100B achieves a computer.

A keyboard 710 is coupled to the input I/F 100F. An input device such as a mouse may be coupled to the input I/F 100F together with the keyboard 710. A display 720 is coupled to the output I/F 100G. Examples of the display 720 include, but are not limited to, a liquid crystal display. A semiconductor memory 730 is coupled to the input/output I/F 100H. Examples of the semiconductor memory 730 include, but are not limited to, a USB memory and a flash memory. The input/output I/F 100H reads programs and data stored in the semiconductor memory 730. The input I/F 100F and the input/output I/F 100H include, for example, USB ports. The output I/F 100G includes, for example, a display port.

A portable storage medium 740 is inserted into the drive device 100I. Examples of the portable storage medium 740 include, but are not limited to, removal discs such as compact disc (CD)-ROMs and digital versatile discs (DVDs). The drive device 100I reads programs and data stored in the portable storage medium 740. The network I/F 100D includes, for example, a port and a physical layer chip (PHY chip) as a network adaptor. The remote connection terminal 100 is coupled to the communication network 400 through the network I/F 100D.

The CPU 100A stores the programs stored in the ROM 100C or the HDD 100E in the above RAM 100B. The CPU 100A stores the programs stored in the portable storage medium 740 in the RAM 100B. The execution of the stored programs by the CPU 100A allows the control device 750 to achieve various functions described later and execute various processes described later. The programs are according to the flowcharts described later.

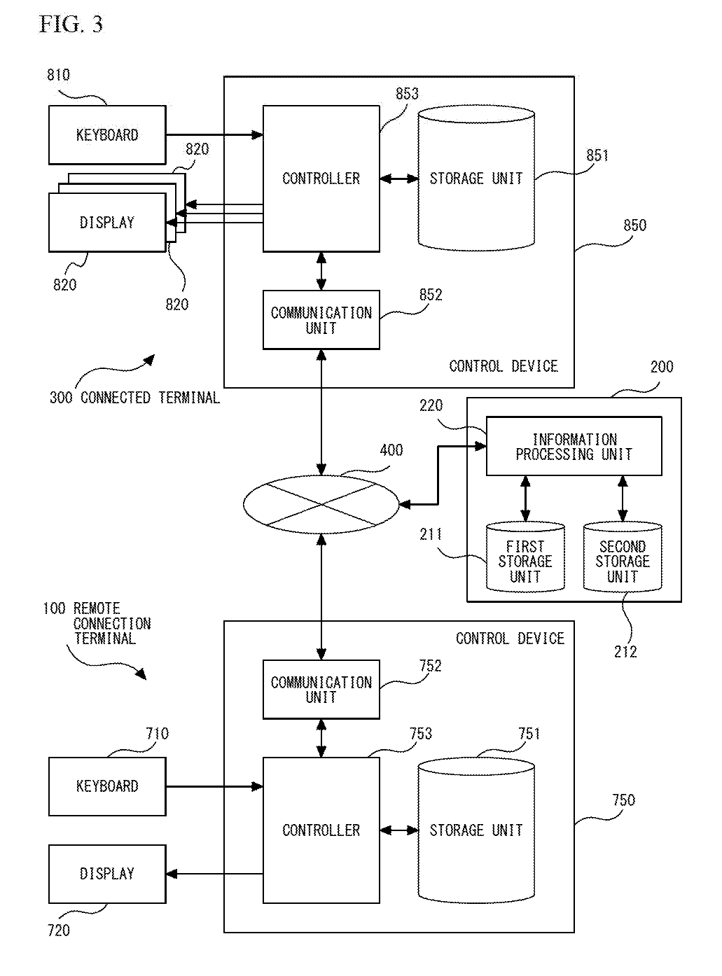

FIG. 3 is an exemplary functional block diagram of the remote connection terminal 100, the server 200, and the connected terminal 300. In FIG. 3, the illustration of the connected terminals 310 and 320 is omitted, but the connected terminals 310 and 320 basically have the same functions as the connected terminal 300. Thus, the description thereof is omitted.

A description will first be given of the remote connection terminal 100. The remote connection terminal 100 includes, as illustrated in FIG. 3, the keyboard 710, the display 720, and the control device 750. The control device 750 includes a storage unit 751, a communication unit 752, and a controller 753 as a processor. The storage unit 751 is implemented by, for example, the above HDD 100E. The communication unit 752 is implemented by, for example, the above network I/F 100D. The controller 753 is implemented by, for example, the CPU 100A and the RAM 100B described above.

The storage unit 751 stores the above programs. For example, when the controller 753 executes a program, the controller 753 implements the function according to the program.

The communication unit 752 controls the communication of the remote connection terminal 100 with the server 200 and the connected terminal 300. For example, the communication unit 752 receives various information transmitted from the server 200 or the connected terminal 300. For example, the communication unit 752 transmits information that requests a predetermined screen including a list of the device information (hereinafter, referred to as a device list screen) to the server 200.

The controller 753 controls the overall operation of the remote connection terminal 100. For example, when receiving an instruction input from the keyboard 710, the controller 753 changes the displayed contents of the display 720 or causes the communication unit 752 to transmit various information according to the contents of the instruction. For example, when the communication unit 752 receives information transmitted from the server 200, the controller 753 changes the displayed contents of the display 720 according to the received information or stores the information in the storage unit 751. Furthermore, the controller 753 executes various processes described later.

A description will next be given of the server 200. The server 200 includes, as illustrated in FIG. 3, a first storage unit 211, a second storage unit 212, and an information processing unit 220. In addition, the server 200 includes a third storage unit that is not illustrated. The first storage unit 211, the second storage unit 212, and the third storage unit are implemented by, for example the above HDD 100E. The information processing unit 220 is implemented by, for example, the CPU 100A, the RAM 100B, and the network I/F 100D described above.

The first storage unit 211 stores state information representing the states of the connected terminals 300, 310, and 320. The state information includes, for example, a connection state, a connection source IP address, a connection destination IP address, and a connection port. The second storage unit 212 stores the NW information that is set to each of the network adapters of the connected terminals 300, 310, and 320. As described above, the NW information includes the priority order, the network I/F type, the network I/F name, the MAC address, the connection state, the IP address, and the subnet mask of the use network. The third storage unit stores the device information for an object of management. The connected terminals 300, 310, and 320 installed in the medical institution are managed with the device information.

The information processing unit 220 executes various information processing. For example, when receiving information that requests the device list screen from the remote connection terminal 100, the information processing unit 220 obtains the device information from the third storage unit. Then, the information processing unit 220 transmits the screen information including the list of the obtained device information to the remote connection terminal 100. Thus, when receiving the screen information, the remote connection terminal 100 displays the device list screen based on the received screen information.

A description will next be given of the connected terminal 300. The connected terminal 300 includes, as illustrated in FIG. 3, a keyboard 810, a plurality of displays 820, and a control device 850. The control device 850 includes a storage unit 851, a communication unit 852, and a controller 853. The storage unit 851 is implemented by, for example, the above HDD 100E. The communication unit 852 is implemented by, for example, the above network I/F 100D. The controller 853 is implemented by, for example, the CPU 100A and the RAM 100B described above.

The storage unit 851 stores the NW information that is set to the communication unit 852 (e.g., the network adapter) of the connected terminal 300. The storage unit 851 stores the state information representing the state of the connected terminal 300. The communication unit 852 controls the communication of the connected terminal 300 with the remote connection terminal 100 and the server 200. For example, the communication unit 852 receives various information (e.g., a connection request) requested from the remote connection terminal 100.

The controller 853 controls the overall operation of the connected terminal 300. For example, when the communication unit 852 receives a connection request from the remote connection terminal 100, the controller 853 causes the communication unit 852 to transmit a response to the connection request to the remote connection terminal 100. This process connects the remote connection terminal 100 to the connected terminal 300. Furthermore, the controller 853 executes various processes.

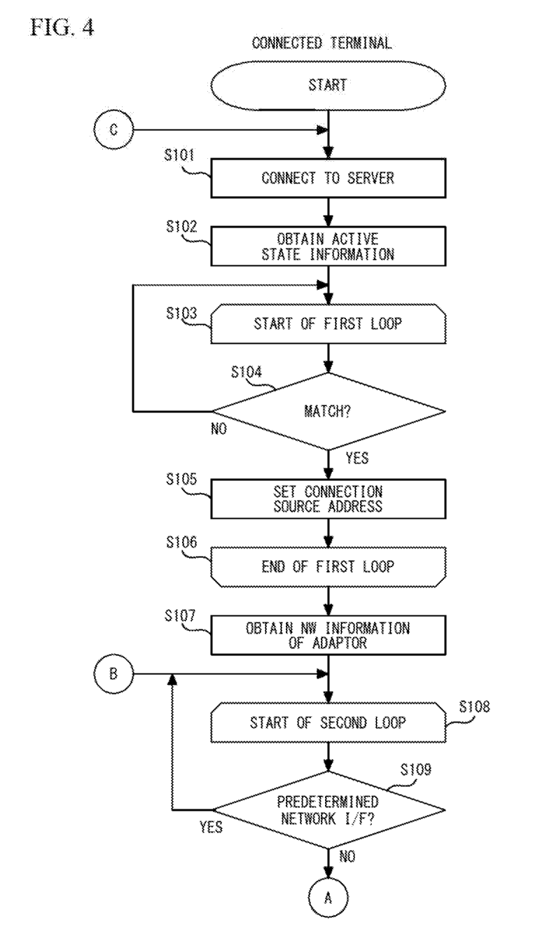

With reference to FIG. 4 through FIG. 7, a description will next be given of a process of gathering the NW information by the connected terminal 300 and processes of registering, updating, and deleting the NW information by the server 200.

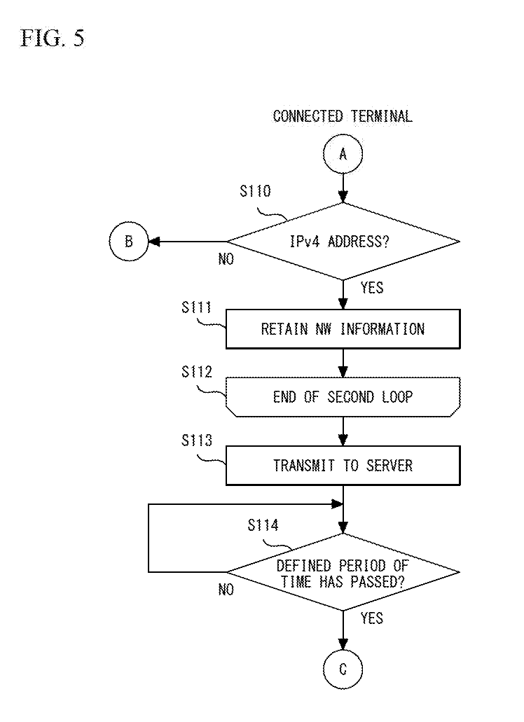

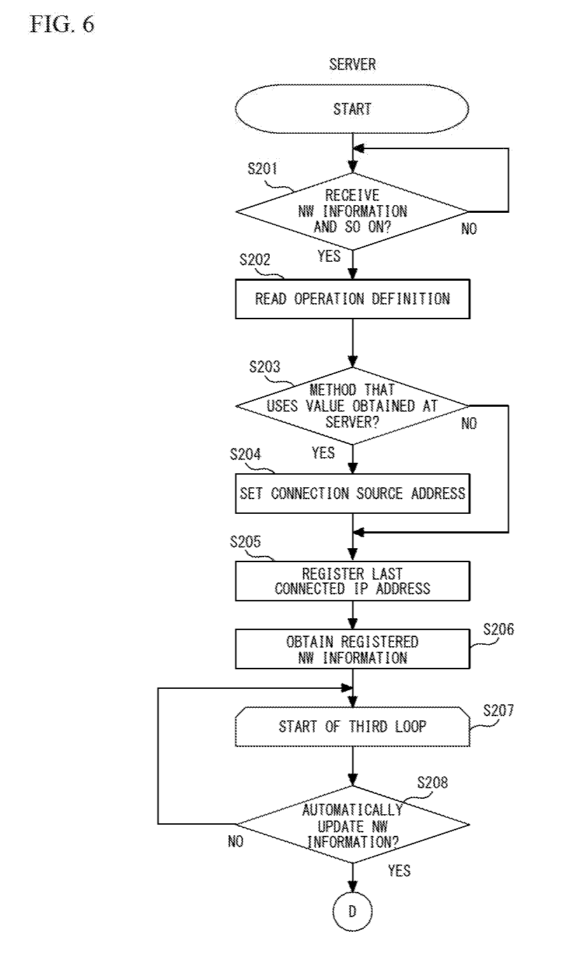

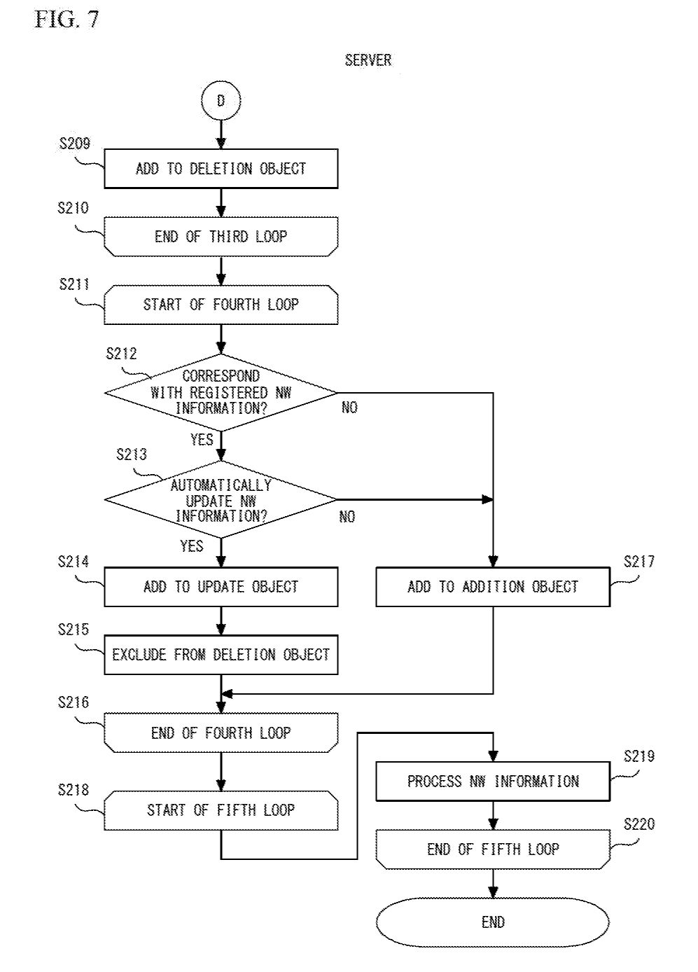

FIG. 4 is a flowchart (No. 1) of an exemplary operation of the connected terminal 300. FIG. 5 is a flowchart (No. 2) of the exemplary operation of the connected terminal 300. FIG. 6 is a flowchart (No. 1) of an exemplary operation of the server 200. FIG. 7 is a flowchart (No. 2) of the exemplary operation of the server 200.

As illustrated in FIG. 4, the controller 853 of the connected terminal 300 connects to the server 200 (step S101). More specifically, the controller 853 connects to the server 200 using Hyper Text Transfer Protocol (HTTP) at a constant frequency. Upon completion of the processing of the step S101, the controller 853 obtains active state information from the communication unit 852 (step S102). That is, the controller 853 gathers the state value of the communication unit 852 and the like autonomously.

Upon completion of the processing of the step S102, the controller 853 starts a first loop (step S103). More specifically, the controller 853 repeats the processes of subsequent steps S104 and S105 for the number of the obtained sets of the state information. When starting the first loop, the controller 853 determines whether the combination of the connection destination IP address and the connection destination port included in the state information matches up with the combination of the server address and the HTTP communication port (step S104).

In the case of mismatch (step S104: NO), the controller 853 returns to the process of the step S103. That is, the controller 853 specifies the next state information, and then starts the first loop again. On the other hand, in the case of match (step S104: YES), the controller 853 sets the connection source IP address included in the state information as a last connected IP address (step S105). The last connected IP address is the IP address that was used most recently. Upon completion of the processing of the step S105, the controller 853 ends the first loop (step S106). This process causes the controller 853 to specify the next state information and start the first loop again.

When the first loop is completed for all the sets of the state information, the controller 853 obtains the NW information of each of all the network adapters (step S107). Upon completion of the processing of the step S107, the controller 853 starts a second loop (step S108). More specifically, the controller 853 repeats the processes of subsequent step S109, S110, and S111 for one or multiple IP addresses included in the obtained NW information.

When the controller 853 starts the second loop, the controller 853 determines whether the network I/F type included in the NW information is a predetermined network I/F (step S109). Examples of the predetermined network I/F include a loop-back I/F and a tunnel I/F. When the network I/F type is the predetermined network I/F (step S109: YES), the controller 853 returns to the process of the step S108. That is, the controller 853 specifies the next IP address, and starts the second loop again.

On the other hand, when the network I/F is not the predetermined network I/F (step S109: NO), as illustrated in FIG. 5, the controller 853 determines whether the IP address included in the NW information is the IPv4 address (step S110). When the IP address is not the IPv4 address (step S110: NO), the controller 853 returns to the process of the step S108 as illustrated in FIG. 4. That is, the controller 853 specifies the next IP address, and starts the second loop again. On the other hand, when the IP address is the IPv4 address (step S110: YES), the controller 853 retains the NW information including the IP address subject to the loop (step S111). Upon completion of the processing of the step S111, the controller 853 ends the second loop (step S112). This process causes the controller 853 to specify the next IP address and start the second loop again.

When the second loop is completed for all the IP addresses, the controller 853 transmits, to the server 200, the last connected IP address set in the process of the step S105 (see FIG. 4) and the NW information retained in the process of the step S111 (step S113). Upon completion of the processing of the step S113, the controller 853 waits until a defined period of time passes (step S114: NO). When the defined period of time has passed (step S114: YES), the controller 853 executes the process of the step S101 illustrated in FIG. 4 again.

On the other hand, as illustrated in FIG. 6, the information processing unit 220 of the server 200 waits until the information processing unit 220 receives the NW information and the like (more specifically, the NW information and the last connected IP address) from the connected terminal 300 (step S201: NO). When receiving the NW information and the like (step S201: YES), the information processing unit 220 reads an operation definition included in an operation definition file (step S202). The operation definition file may be stored in the first storage unit 211 or the second storage unit 212, or may be stored in a storage unit different from the first storage unit 211 and the second storage unit 212. The operation definition file includes a method of obtaining the last connected IP address as the operation definition. More specifically, one of the method that uses the value obtained at the connected terminal 300 and the method that uses the value obtained at the server 200 is defined as the method of obtaining the last connected IP address.

Upon completion of the processing of the step S202, the information processing unit 220 determines whether the method of obtaining the last connected IP address is the method that uses the value obtained at the server 200 (step S203). When the method of obtaining the last connected IP address is the method that uses the value obtained at the server 200 (step S203: YES), the information processing unit 220 sets the source address as the last connected IP address (step S204). On the other hand, when the method of obtaining the last connected IP address is not the method that uses the value obtained at the server 200 (step S203: NO), the information processing unit 220 skips the process of the step S204. That is, when the method of obtaining the last connected IP address is the method that uses the value obtained at the remote connection terminal 100, the information processing unit 220 skips the process of the step S204.

When the process of the step S204 is completed, or when the process of the step S204 is skipped, the information processing unit 220 registers the last connected IP address (step S205). More specifically, the information processing unit 220 registers the last connected IP address in the first storage unit 211, and updates the state information stored in the first storage unit 211. Since the connection source address or the source address is set as the last connected IP address, the connection source address or the source address is registered in the first storage unit 211.

Upon completion of the processing of the step S205, the information processing unit 220 obtains the registered NW information from the second storage unit 212 (step S206). Upon completion of the processing of the step S206, the controller 753 starts a third loop (step S207). More specifically, the controller 753 repeats the processes of subsequent steps S208 and S209 for the number of the obtained sets of the NW information that have been registered.

When starting the third loop, the information processing unit 220 determines whether to automatically update the NW information (step S208). More specifically, the information processing unit 220 determines whether to automatically update the NW information based on the setting of automatic update described later. When not automatically updating the NW information (step S208: NO), the information processing unit 220 returns to the process of the step S207. That is, the information processing unit 220 specifies the next registered NW information, and starts the third loop again. On the other hand, when automatically updating the NW information (step S208: YES), as illustrated in FIG. 7, the information processing unit 220 adds the subject NW information to a deletion object (step S209). Upon completion of the processing of the step S209, the information processing unit 220 ends the third loop (step S210). This process causes the information processing unit 220 to specify the next registered NW information and starts the third loop again.

When the third loop is completed for all the registered sets of the NW information, the information processing unit 220 starts a fourth loop (step S211). More specifically, the information processing unit 220 repeats the processes of subsequent steps S212, S213, S214, S215, and S217 for the number of sets of the NW information received from the connected terminal 300.

When starting the fourth loop, the information processing unit 220 determines whether the received NW information corresponds with the registered NW information (step S212). More specifically, the information processing unit 220 determines whether the received MAC address corresponds with the registered MAC address. When the received NW information corresponds with the registered NW information (step S212: YES), the information processing unit 220 determines whether to automatically update the NW information (step S213). When automatically updating the NW information (step S213: YES), the information processing unit 220 adds the NW information to an update object (step S214). Upon completion of the processing of the step S214, the information processing unit 220 excludes the NW information from the deletion object (step S215). Upon completion of the processing of the step S215, the information processing unit 220 ends the fourth loop (step S216).

On the other hand, when the received NW information does not correspond with the registered NW information (step S212: NO) or when not automatically updating the NW information (step S213: NO), the information processing unit 220 adds the NW information to an addition object (step S217). Upon completion of the processing of the step S217, the information processing unit 220 ends the fourth loop.

When the fourth loop is completed for all the received sets of the NW information, the information processing unit 220 starts a fifth loop (step S218). More specifically, the information processing unit 220 repeats the process of a subsequent step S219 for the number of sets of the NW information added to the addition object, the NW information added to the update object, and the NW information added to the deletion object.

When starting the fifth loop, the information processing unit 220 processes the NW information based on the process category (step S219). More specifically, when the NW information is the NW information added to the addition object, the information processing unit 220 registers the NW information in the second storage unit 212. When the NW information is the NW information added to the update object, the information processing unit 220 updates the NW information stored in the second storage unit 212. When the NW information is the NW information added to the deletion object, the information processing unit 220 deletes the NW information from the second storage unit 212. Upon completion of the processing of the step S219, the information processing unit 220 ends the fifth loop (step S220). The above processes cause the NW information to be registered in the second storage unit 212, the NW information stored in the second storage unit 212 to be updated, and the NW information to be deleted from the second storage unit 212.

The processes by the connected terminal 300 and the server 200 described with reference to FIG. 4 through FIG. 7 cause the first storage unit 211 to store the state information and the second storage unit 212 to store the NW information.

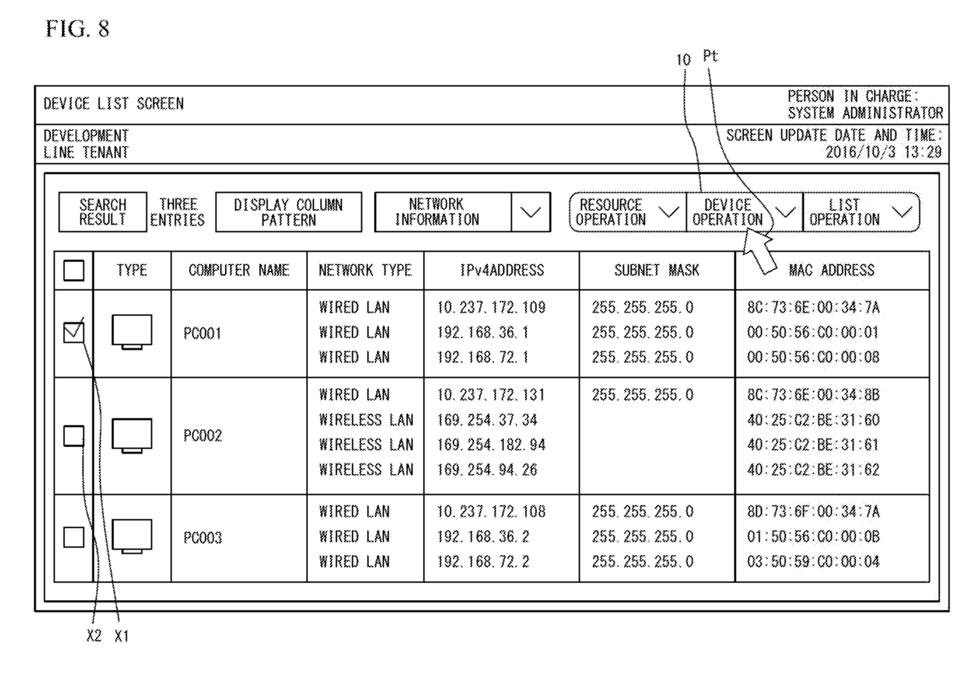

A description will next be given of operations of the remote connection terminal 100 and the server 200 for displaying the device list screen with reference to FIG. 8.

FIG. 8 illustrates the device list screen in accordance with the first embodiment. When receiving an instruction to request the device list screen from the keyboard 710, the controller 753 of the remote connection terminal 100 generates information that requests the device list screen. When the controller 753 generates the information that requests the device list screen, the communication unit 752 transmits the generated information to the server 200.

When receiving the information that requests the device list screen, the information processing unit 220 of the server 200 transmits the screen information of the device list screen to the remote connection terminal 100. This process causes the remote connection terminal 100 to display the device list screen as illustrated in FIG. 8. On the device list screen, displayed is at least one of items of the device information stored in the third storage unit. For example, in the columns for the computer name, displayed are the names of the connected terminals 300, 310, and 320. For example, in the columns for the IPv4 address, displayed are the IP addresses assigned to the connected terminals 300, 310, and 320. This configuration enables the administrator to check various information about the connected terminals 300, 310, and 320 managed by the server 200.

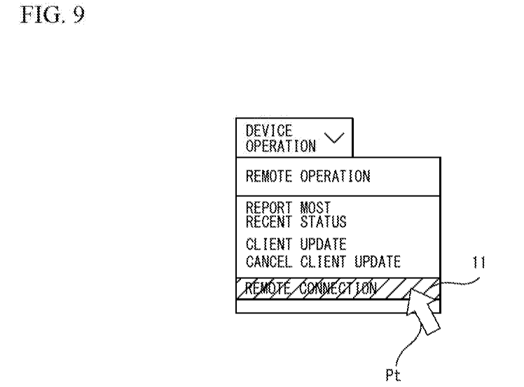

With reference to FIG. 9 through FIG. 12, a description will be given of a process for displaying a remote operation screen used to connect to the connected terminal 300.

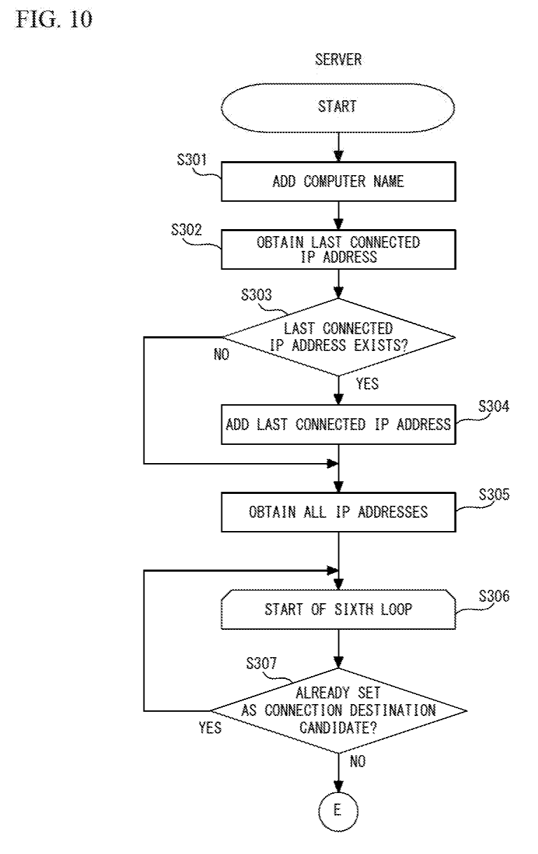

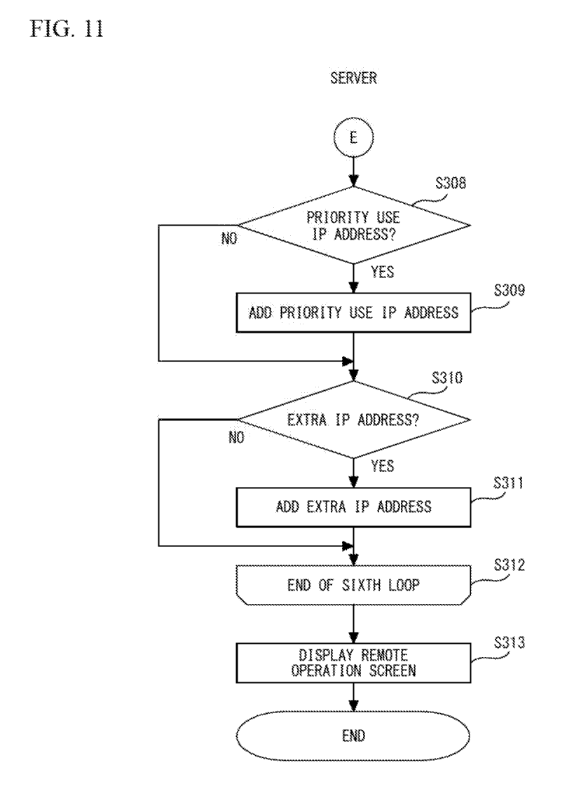

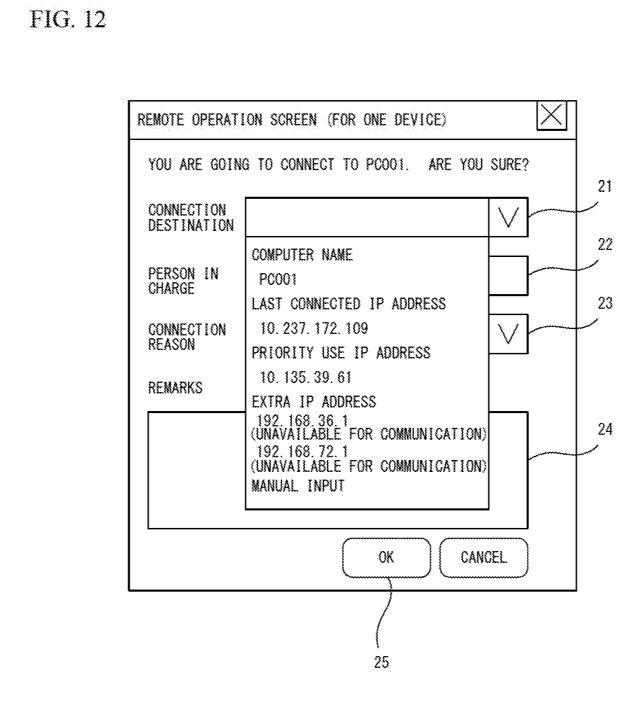

FIG. 9 illustrates a state where a device operation is expanded. FIG. 10 is a flowchart (No. 3) of another exemplary operation of the server 200. FIG. 11 is a flowchart (No. 4) of the exemplary operation of the server 200. FIG. 12 illustrates the remote operation screen in accordance with the first embodiment.

When receiving an instruction to request the remote operation screen from the keyboard 710, the controller 753 of the remote connection terminal 100 generates information that requests the remote operation screen. More specifically, when one specific item X1 (e.g., a check box) on the device list screen is specified by a pointer Pt and a specific image 10 (e.g., a device operating button) is then operated as illustrated in FIG. 8, the controller 753 receives the operation, expands the image 10, and displays a plurality of selection items on the display 720 as illustrated in FIG. 9. Furthermore, as illustrated in FIG. 9, when a specific selection item 11 is operated by the pointer Pt, the controller 753 receives the operation and generates information that requests a remote operation screen for one device. When the controller 753 generates the information that requests the remote operation screen for one device, the communication unit 752 transmits the generated information to the server 200. Although the details will be described in a second embodiment, when two specific items X1 and X2 are specified, the controller 753 generates information that requests a remote operation screen for multiple devices.

When receiving the information that requests the remote operation screen for one device, the information processing unit 220 of the server 200 adds the computer name to a connection destination candidate based on the received information as illustrated in FIG. 10 (step 301). For example, when the received information includes the computer name “PC001”, the information processing unit 220 adds the computer name “PC001” to the connection destination candidate. Upon completion of the processing of the step S301, the information processing unit 220 obtains the last connected IP address from the first storage unit 211 based on the received information (step S302). Upon completion of the processing of the step S302, the information processing unit 220 determines whether the last connected IP address exists (step S303). In other words, the information processing unit 220 determines whether the information processing unit 220 was able to obtain the last connected IP address at the step S302.

When the last connected IP address exists (step S303: YES), the information processing unit 220 adds the obtained last connected IP address to the connection destination candidate (step S304). When the last connected IP address does not exist (step S303: NO), the information processing unit 220 skips the process of the step S304.

When the process of the step S304 is completed, or when the process of the step S304 is skipped, the information processing unit 220 obtains all the IP addresses set to each of the connected terminals 300, 310, and 320 from the second storage unit 212 (step S305). Upon completion of the processing of the step S305, the information processing unit 220 starts a sixth loop (step S306). More specifically, the information processing unit 220 repeats the processes of subsequent steps S307, S308, S309, S310, and S311 for the number of the obtained IP addresses.

When starting the sixth loop, the information processing unit 220 determines whether the IP address subject to the loop is already set as the connection destination candidate (step S307). When the IP address is already set (step S307: YES), the information processing unit 220 returns to the process of the step S306. That is, the information processing unit 220 specifies the next IP address and starts the sixth loop again.

On the other hand, when the IP address is not set yet (step S307: NO), the information processing unit 220 determines whether the IP address subject to the loop is a predetermined priority use IP address as illustrated in FIG. 11 (step S308). When the IP address is the priority use IP address (step S308: YES), the information processing unit 220 adds the priority use IP address to the connection destination candidate (step S309). When the IP address is not the priority use IP address (step S308: NO), the information processing unit 220 skips the process of the step S309.

When the process of the step S309 is completed, or when the process of the step S309 is skipped, the information processing unit 220 determines whether the IP address is an extra IP address (step S310). When the IP address is the extra IP address (step S310: YES), the information processing unit 220 adds the extra IP address to the connection destination candidate (step S311). When the IP address is not the extra IP address (step S310: NO), the information processing unit 220 skips the process of the step S311. Upon completion of the processing of the step S311, the information processing unit 220 ends the sixth loop (step S312).

When the sixth loop is completed for all the IP addresses, the information processing unit 220 displays the remote operation screen (step S313). More specifically, the information processing unit 220 transmits the screen information of the remote operation screen for one device to the remote connection terminal 100. This process causes the remote connection terminal 100 to display the remote operation screen for one device as illustrated in FIG. 12.

On the remote operation screen, displayed are a selection field 21 for selecting a connection method to a connection destination, an entry field 22 for inputting a person in charge who conducts a remote operation, a selection field 23 for selecting a connection reason, and an entry field 24 for inputting remarks. When the controller 753 receives an instruction to expand the selection field 21, the controller 753 displays used IP addresses that were used for communication in the past as candidates distinctively from other IP addresses that were not used in the past. Especially when the last connected IP address differs from the priority use IP address, the controller 753 displays the last connected IP address and the priority use IP address distinctively from each other. Additionally, the controller 753 displays an IP address unavailable for communication in combination with a predetermined text indicating that the IP address is unavailable for communication. When the used IP address is an IP address of wired connection, the controller 753 may display the used IP addresses of wired connection distinctively from other IP addresses. This configuration enables the administrator to instantly understand that the IP address displayed by the expansion of the selection field 21 is the IP address of wired connection. As described above, through the remote operation screen, the administrator can select the connection method to the connected terminal 300 that is subject to a remote connection.

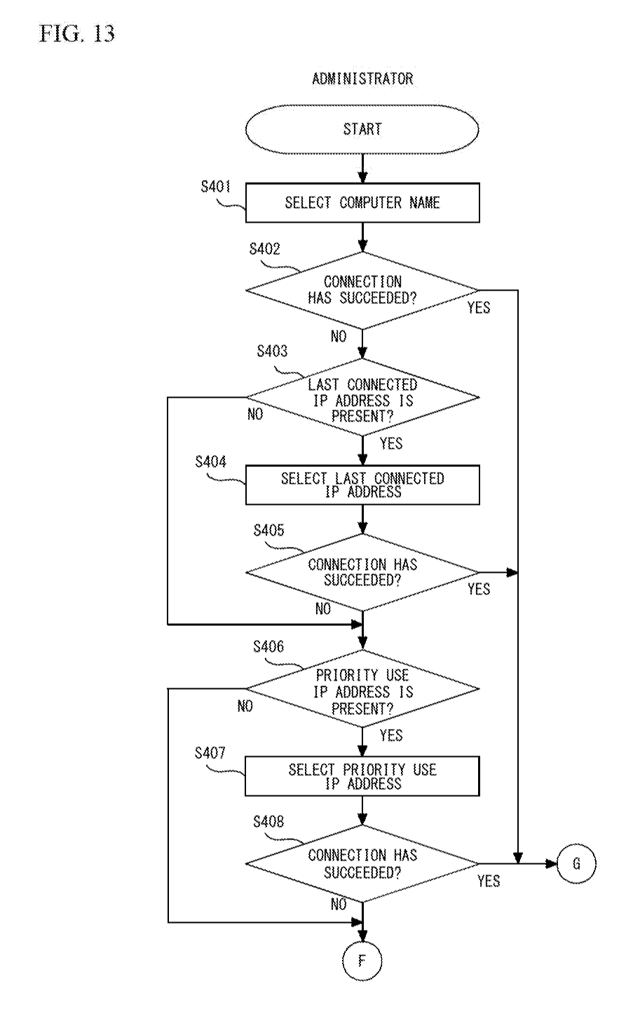

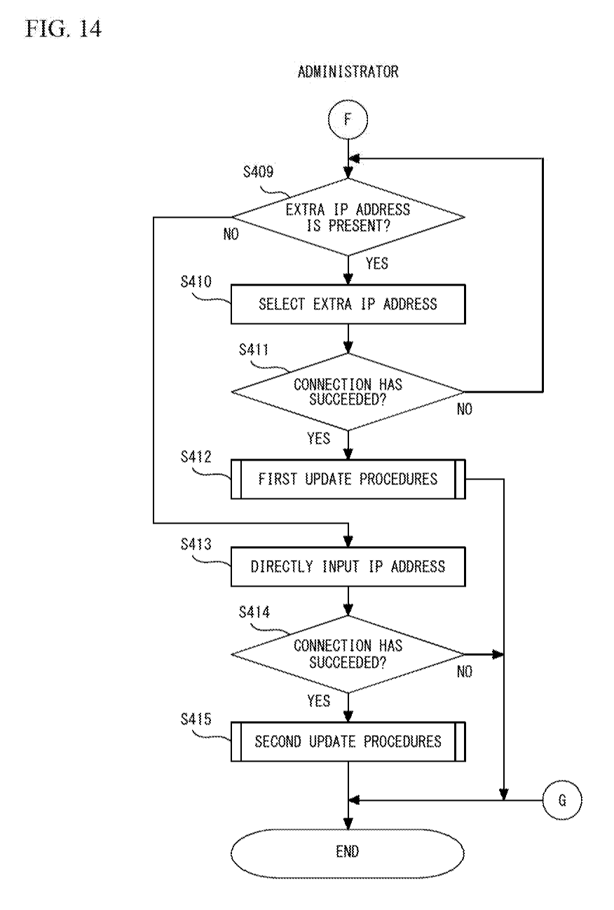

A description will next be given of selection procedures by the administrator operating the remote connection terminal 100 with reference to FIG. 13 and FIG. 14. FIG. 13 is a flowchart (No. 1) of exemplary selection procedures by the administrator. FIG. 14 is a flowchart (No. 2) of the exemplary selection procedures by the administrator.

As illustrated in FIG. 13, the administrator selects a computer name for the connection destination on the remote operation screen (see FIG. 12) (step S401). After selecting a computer name, the administrator operates a specific image 25 (e.g., an OK button), and determines whether the connection has succeeded (step S402).

When the connection has succeeded (step S402: YES), the administrator ends the connection operation as illustrated in FIG. 14. That is, the administrator determines that the connection to the connected terminal 300 has succeeded by using the computer name. On the other hand, when the connection has failed (step S402: NO), the administrator determines whether the last connected IP address is present on the remote operation screen (step S403). When the last connected IP address is present (step S403: YES), the administrator selects the last connected IP address for the connection destination on the remote operation screen (step S404). After selecting the last connected IP address, the administrator operates the specific image 25, and determines whether the connection has succeeded (step S405).

When the connection has succeeded (step S405: YES), the administrator ends the connection operation as illustrated in FIG. 14. That is, the administrator determines that the connection with the connected terminal 300 has succeeded by using the last connected IP address. On the other hand, when the connection has failed (step S405: NO), the administrator determines whether the priority use IP address is present on the remote operation screen (step S406). When the priority use IP address is present (step S406: YES), the administrator selects the priority use IP address for the connection destination on the remote operation screen (step S407). After selecting the priority use IP address, the administrator operates the specific image 25 and then determines whether the connection has succeeded (step S408).

When the connection has succeeded (step S408: YES), as illustrated in FIG. 14, the administrator ends the connection operation. That is, the administrator determines that the connection with the connected terminal 300 has succeeded by using the priority use IP address. On the other hand, when the connection has failed (step S408: NO), as illustrated in FIG. 14, the administrator determines whether the extra IP address is present on the remote operation screen (step S409). When the extra IP address is present (step S409: YES), the administrator selects the extra IP address for the connection destination on the remote operation screen (step S410). After selecting the extra IP address, the administrator operates the specific image 25 and then determines whether the connection has succeeded (step S411).

When the connection has succeeded (step S411: YES), the administrator executes first update procedures described later (step S412), and then ends the connection operation. On the other hand, when the connection has failed (step S411: NO), the administrator executes the process of the step S409 again. When the extra IP address is absent (step S409: NO), the administrator directly inputs an IP address on the remote operation screen with the keyboard 710 (step S413). After inputting an IP address, the administrator operates the specific image 25 and then determines whether the connection has succeeded (step S414).

When the connection has succeeded (step S414: YES), the administrator executes second update procedures described later (step S415) and ends the connection operation. On the other hand, when the connection has failed (step S414: NO), the step S415 is skipped, and the connection operation is ended. This means that the connection with the connected terminal 300 was not established by using any selected computer names or IP addresses.

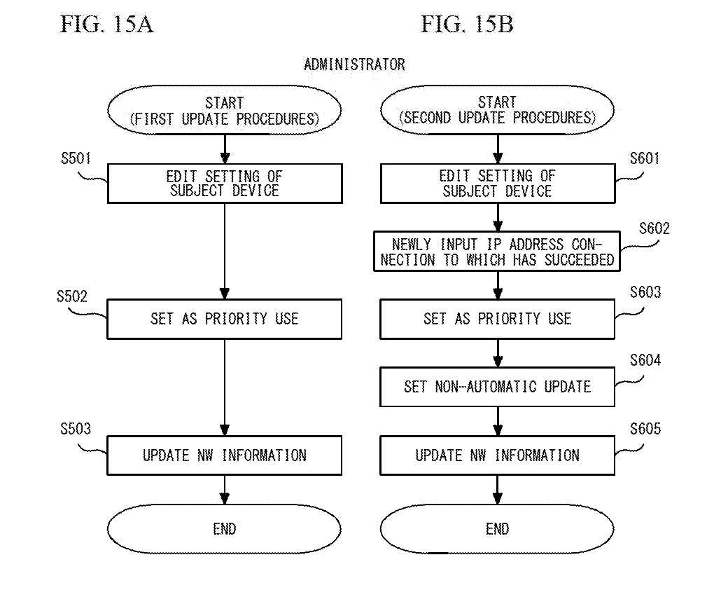

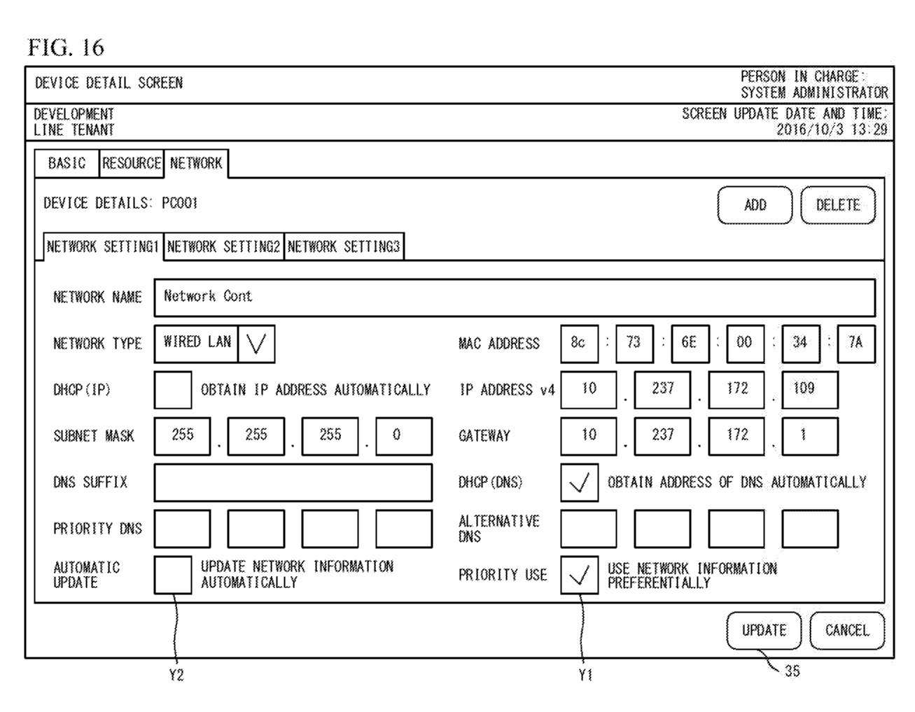

A description will next be given of the first update procedures and the second update procedures mentioned above with reference to FIG. 15A through FIG. 16. FIG. 15A is a flowchart of the first update procedures. FIG. 15B is a flowchart of the second update procedures. FIG. 16 illustrates a device detail screen.

When the connection has succeeded at the above step S411, as illustrated in FIG. 15A, the administrator edits the setting of the subject device (step S501). More specifically, as illustrated in FIG. 16, the administrator edits the network setting of the subject device by using the device detail screen displayed on the remote connection terminal 100. At this time, the controller 753 dynamically displays the IP address the connection to which has succeeded in the field for the IP address (v4) on the device detail screen. Thus, the administrator specifies a specific item Y1 (for example, a check box) representing the setting of the priority use on the device detail screen to set the priority use (step S502). This process causes the extra IP address to be displayed as the priority use IP address from the next time. After the process of the step S502, the administrator operates a specific image 35 (e.g., an update button) to update the NW information stored in the second storage unit 212 (step S503).

When the connection has succeeded at the above step S414, as illustrated in FIG. 15B, the administrator edits the setting of the subject device (step S601). As described above, the administrator edits the network setting of the subject device by using the device detail screen (see FIG. 16) displayed on the remote connection terminal 100. At this time, the administrator newly inputs the IP address the connection to which has succeeded in the field for the IP address (v4) on the device detail screen (step S602).

After the process of the step S602, the administrator specifies the specific item Y1 on the device detail screen to set the priority use (step S603). This process causes the directly-input IP address to be displayed as the priority use IP address from the next time. After the process of the step S603, the administrator unspecifies a specific item Y2 (for example, a check box) representing the setting of the automatic update on the device detail screen, and sets non-automatic update (step S604). This process prevents the information from being overwritten by the information obtained from the connected terminal 300. After the process of the step S604, the administrator operates the specific image 35 to update the NW information stored in the second storage unit 212 (step S605).

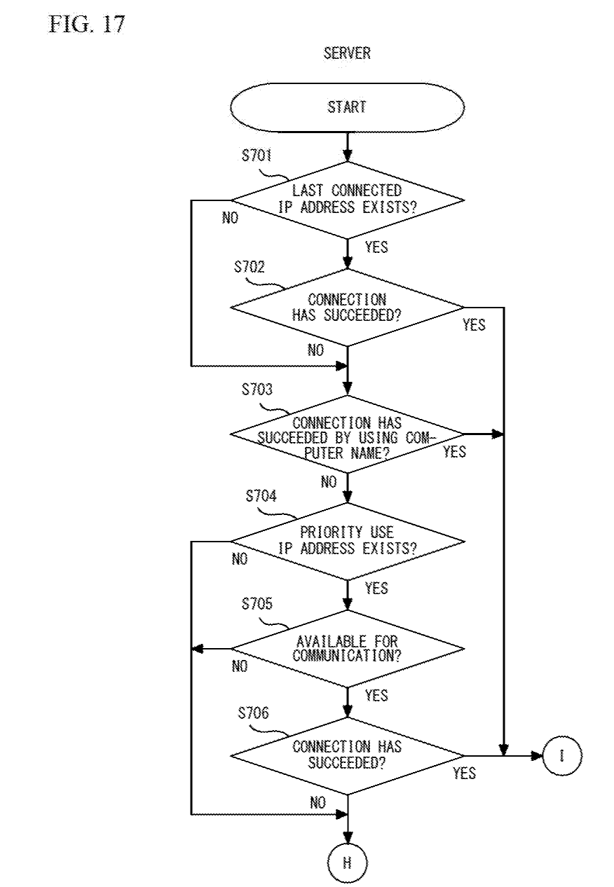

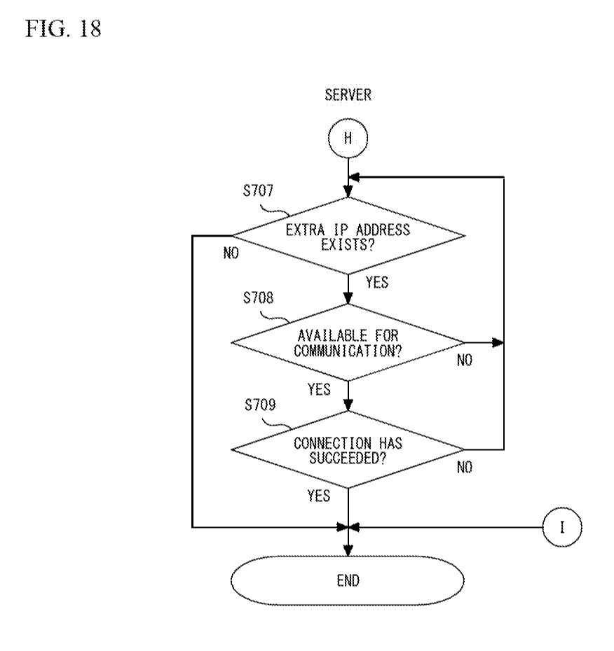

A description will next be given of a dynamic cyclic process of the connection destination candidate by the server 200 with reference to FIG. 17 and FIG. 18.

FIG. 17 is a flowchart (No. 5) of the exemplary operation of the server 200. FIG. 18 is a flowchart (No. 6) of the exemplary operation of the server 200. When receiving an instruction to report the latest connection information from the remote connection terminal 100, as illustrated in FIG. 17, the information processing unit 220 of the server 200 determines whether the last connected IP address exists (step S701). When the last connected IP address exists (step S701: YES), the information processing unit 220 determines whether the connection has succeeded by using the last connected IP address (step S702). When the last connected IP address does not exist (step S701: NO), the information processing unit 220 skips the process of the step S702.

When the connection has succeeded (step S702: YES), as illustrated in FIG. 18, the information processing unit 220 ends the dynamic cyclic process. On the other hand, when the connection has failed (step S702: NO), the information processing unit 220 determines whether the connection has succeeded by using the computer name (step S703). When the connection has succeeded (step S703: YES), as illustrated in FIG. 18, the information processing unit 220 ends the dynamic cyclic process. On the other hand, when the connection has failed (step S703: NO), the information processing unit 220 determines whether the priority use IP address exists (step S704).

When the priority use IP address exists (step S704: YES), the information processing unit 220 determines whether the priority use IP address is available for communication (step S705). When the priority use IP address is available for communication (step S705: YES), the information processing unit 220 determines whether the connection has succeeded by using the priority use IP address (step S706).

When the connection has succeeded (step S706: YES), as illustrated in FIG. 18, the information processing unit 220 ends the dynamic cyclic process. On the other hand, when the priority use IP address does not exist (step S704: NO), when the priority use IP address is unavailable for communication (step S705: NO), or when the connection has failed (step S706: NO), as illustrated in FIG. 18, the information processing unit 220 determines whether the extra IP address exists (step S707).

When the extra IP address exists (step S707: YES), the information processing unit 220 determines whether the extra IP address is available for communication (step S708). When the extra IP address is available for communication (step S708: YES), the information processing unit 220 determines whether the connection has succeeded by using the extra IP address (step S709).

When the connection has succeeded (step S709: YES), the information processing unit 220 ends the dynamic cyclic process. On the other hand, when the extra IP address is unavailable for communication (step S708: NO) or when the connection has failed (step S709: NO), the information processing unit 220 executes the step S707. When the extra IP address does not exist (step S707: NO), the information processing unit 220 ends the dynamic cyclic process. When ending the dynamic cyclic process, the information processing unit 220 transmits the processing result to the remote connection terminal 100. This process enables the administrator to check the latest connection status.

As described above, in the first embodiment, the remote connection terminal 100 includes the controller 753. The controller 753 directly or indirectly obtains from the specific connected terminal 300, 310, or 320 one or multiple IP addresses assigned to the connected terminal 300, 310, or 320. That is, the controller 753 may obtain one or multiple IP addresses assigned to the connected terminal 300, 310, or 320 from the server 200. At the time of displaying the obtained one or multiple IP addresses as the candidate for the IP address used to remotely control the connected terminal 300, 310, or 320, when the candidate includes the used IP address that was used for communication between the connected terminal 300, 310, or 320 and the remote connection terminal 100 in the past, the controller 753 displays the used IP address distinctively from other IP addresses. This configuration assists the selection of the IP address with high probability of successful connection.

### Second Embodiment

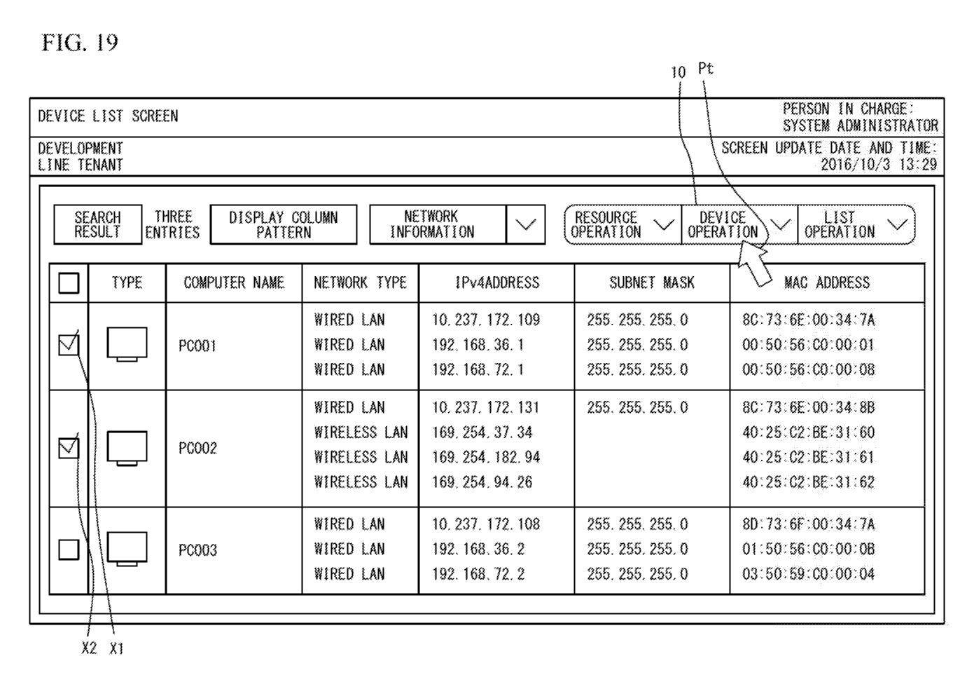

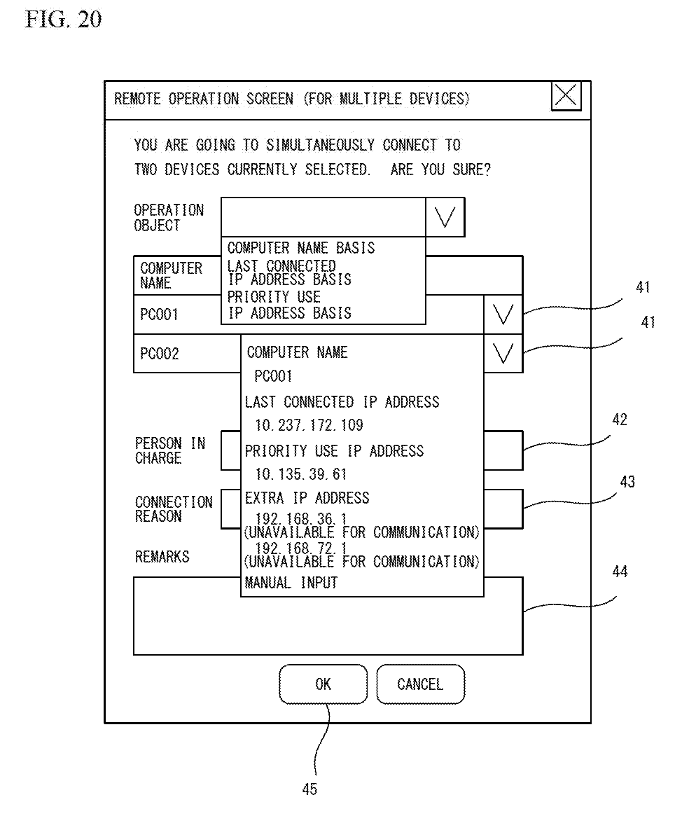

A description will next be given of the second embodiment with reference to FIG. 19 and FIG. 20. FIG. 19 illustrates the device list screen in accordance with the second embodiment. FIG. 20 illustrates the remote operation screen in accordance with the second embodiment.

In the first embodiment, as described with reference to FIG. 8, when one specific item X1 is specified by the pointer Pt and the specific image 10 is then operated, the controller 753 receives the operation, expands the image 10, and displays a plurality of selection items on the display 720 as illustrated in FIG. 9.

On the other hand, in the second embodiment, as described with reference to FIG. 19, when two specific items X1 and X2 are specified by the pointer Pt and the specific image 10 is then operated, the controller 753 receives the operation, expands the image 10, and displays a plurality of selection items on the display 720 as in the first embodiment (see FIG. 9).

Furthermore, when the specific selection item 11 is operated with the pointer Pt (see FIG. 9), the controller 753 receives the operation and generates information that requests the remote operation screen for multiple devices. When the controller 753 generates the information that requests the remote operation screen for multiple devices, the communication unit 752 transmits the generated information to the server 200.

When receiving the information that requests the remote operation screen for multiple devices, the information processing unit 220 of the server 200 transmits the screen information of the remote operation screen for multiple devices to the remote connection terminal 100. This configuration causes the remote connection terminal 100 to display the remote operation screen for multiple devices as illustrated in FIG. 20. On the remote operation screen, displayed are a plurality of selection fields 41 for selecting a connection method of a connection destination, an entry field 42 for inputting a person in charge who conducts a remote operation, a selection field 43 for inputting a connection reason, and an entry field 44 for inputting remarks. As in the first embodiment, when receiving an instruction to expand the selection field 41, the controller 753 displays the used IP addresses that were used for communication in the past as candidates distinctively from other IP addresses that were not used in the past. As described above, through the remote operation screen for multiple devices, the administrator can separately selects the connection method to the connected terminal 300, which is subject to a remote connection, with respect to each computer name.

Alternatively, as illustrated in FIG. 20, in the remote operation screen for multiple devices, connection methods of operation targets can be selected collectively. For example, when “computer name basis” is selected as the connection methods of the operation targets, the controller 753 dynamically displays computer names in the selection fields 41. For example, when “last connected IP address basis” is selected as the connection methods of the operation targets, the controller 753 dynamically displays the last connected IP addresses in the selection fields 41. For example, when “priority use IP address basis” is selected as the connection methods of the operation targets, the controller 753 dynamically displays the priority use IP addresses in the selection fields 41. As described above, even when the remote connection terminal 100 simultaneously connects to the connected terminals 300, 310, and 320, the selection of the IP address with high probability of successful connection is assisted with respect to each connection destination.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention. For example, the IP address is used as an example in the above first and second embodiments, but the MAC address may be used instead of the IP address.

What is claimed is:

1. A non-transitory computer-readable storage medium storing a control program that causes a processor to execute a process, the process comprising:
obtaining from a specific device one or multiple network addresses assigned to the specific device; and
at a time of displaying the obtained one or multiple network addresses as a candidate for a network address used to remotely control the specific device, when the candidate includes a used network address that was used for past communication between the specific device and the processor, displaying the used network address distinctively from a remaining network address.

2. The non-transitory computer-readable storage medium according to claim 1, wherein
the displaying includes displaying a most-recently used network address and a predetermined used network address distinctively from each other when the most-recently used network address differs from the predetermined used network address.

3. The non-transitory computer-readable storage medium according to claim 1, wherein
the displaying includes, when the used network address is a network address of wired connection, displaying the used network address of wired connection distinctively from the remaining network address.

4. The non-transitory computer-readable medium according to claim 1, wherein
the displaying includes, when communication with the specific device to which the used network address is assigned is unavailable, displaying the used network address assigned to the specific device in combination with a predetermined text indicating that communication is unavailable.

5. The non-transitory computer-readable medium according to claim 1, wherein
the obtaining includes obtaining from each of a plurality of specific devices one or multiple network addresses assigned to each of the plurality of specific devices; and
the displaying includes, at a time of displaying the obtained one or multiple network addresses as a candidate for a network address used to remotely control each of the plurality of specific devices, when the candidate includes a used network address that was used for past communication between each of the plurality of specific devices and the processor, displaying the used network address distinctively from the remaining network address with respect to each of names given to the plurality of specific devices.

6. A control method implemented by a processor, the method comprising:
obtaining from a specific device one or multiple network addresses assigned to the specific device; and
at a time of displaying the obtained one or multiple network addresses as a candidate for a network address used to remotely control the specific device, when the candidate includes a used network address that was used for past communication between the specific device and the processor, displaying the used network address distinctively from a remaining network address.

7. An information processing device comprising:
a processor configured to:
obtain from a specific device one or multiple network addresses assigned to the specific device; and
at a time of displaying the obtained one or multiple network addresses as a candidate for a network address used to remotely control the specific device, when the candidate includes a used network address that was used for past communication the specific device and the information processing device, display the used network address distinctively from a remaining network address.

8. The information processing device according to claim 7, wherein
the processor is configured to
display a most-recently used network address and a predetermined used network address distinctively from each other when the most-recently used network address differs from the predetermined used network address.

9. The information processing device according to claim 7, wherein
the processor is configured to
when the used network address is a network address of wired connection, display the used network address of wired connection distinctively from the remaining network address.

10. The information processing device according to claim 7, wherein
the processor is configured to
when communication with the specific device to which the used network address is assigned is unavailable, display the used network address assigned to the specific device in combination with a predetermined text indicating that communication is unavailable.

11. The information processing device according to claim 7, wherein
the processor is configured to:
obtain from each of a plurality of specific devices one or multiple network addresses assigned to each of the plurality of specific devices; and
at a time of displaying the obtained one or multiple network addresses as a candidate for a network address used to remotely control each of the plurality of specific devices, when the candidate includes a used network address that was used for past communication between each of the plurality of specific devices and the information processing device, display the used network address distinctively from the remaining network address with respect to each of names given to the plurality of specific devices.
